(19) United States
(12) Patent Application Publication
(10) Pub. No.: US 2002/0178998 A1
(43) Pub. Date: Dec. 5, 2002

(54) Flag sets

(76) Inventor: Takuya Okumura, Nagoya (JP)

Correspondence Address: LYON & LYON LLP, 633 WEST FIFTH STREET, SUITE 4700, LOS ANGELES, CA, 90071, US

(21) Appl. No.: 10/159,189

(22) Filed: May 31, 2002

(30) Foreign Application Priority Data
Jun. 1, 2001 (JP) 2001-167242

(51) Int. Cl. G09F 17/00

(52) U.S. Cl. 116/174

(57) ABSTRACT

Flag sets may include a flag (20) attached to a flagpole (10). An upper-end joining loop (22a) may be disposed at the upper side edge of the flag (20). A joining part (54) may be rotatably disposed at the upper end of the flagpole (10) and may be coupled to the upper-end joining loop (22a) without wrapping the upper-end joining loop (22a) around the flagpole (10). A lower-end joining loop (22b) may be disposed at a lower side of the flag (20). A flagpole collar (80) may be rotatably disposed on the flagpole (10). The lower-end joining loop (22b) may be coupled to a joining part (84) defined within the flagpole collar (80) without wrapping the lower-end joining loop (22b) around the flagpole (10).

This application claims priority to Japanese patent application serial number 2001-167242, the contents of which are incorporated herein by reference.

### BACKGROUND OF THE INVENTION

1. Technical Field

The present invention relates to flag sets and more particularly, to techniques for attaching a flag to a flagpole.

2. Description of the Related Art

Known flag sets generally include a flag or banner attached to a flagpole. The flag may include a plurality of loops disposed along on the edge of the flag that is closest to the flagpole. When the flagpole is inserted through the loops, the loops will surround the flagpole and the flag will be attached to the flagpole.

However, it is inconvenient to insert the flagpole though the loops in order to attach the flag to the flagpole. For example, “banner-type” flags are longer in the longitudinal direction than the lateral direction and can be particularly cumbersome to attach to a flagpole using known methods.

### SUMMARY OF THE INVENTION

It is, accordingly, one object of the present teachings is to provide improved flag sets. For example, a flag may include at least one joining loop disposed along a side edge of the flag. Further, at least one joining part may be attached to a flagpole that permits the joining loop to be coupled to the flagpole without wrapping the joining loop around the flagpole.

Thus, in one aspect of the present teachings, a flagpole connection member may be disposed along a side edge of the flag and the flagpole connection member may include a joining loop. The joining loop of the flagpole connection member may be connected or coupled to a joining part that disposed at an upper end of the flagpole without wrapping the joining loop around the flagpole. As a result, the flag can be easily and efficiently attached to the flagpole.

“A flagpole connection member having a joining loop” includes a joining loop that is disposed on the front end of the flagpole connection member and flagpole connection members that are formed by the joining loop. The terms “lower-end flagpole connection member” and “the intermediate height flagpole connection member” are intended to have substantially the same meaning.

In another aspect of the present teachings, a lower-end flagpole connection member having a joining loop may be disposed on a lower side edge of the flag on the flagpole side of the flag. A flagpole collar may be attached to the flagpole through an insertion hole defined within the flagpole collar. The joining loop of the lower-end flagpole connection member may be connected or coupled to the joining part of the flagpole collar without wrapping the joining loop around the flagpole. In this aspect as well, the flag can be easily and efficiently attached to the flagpole.

In another aspect of the present teachings, an intermediate height flagpole connection member also may include a joining loop and may be provided at an intermediate portion of the side edge of the flag on the flagpole side of the flag. Another flagpole collar similar to the above-described flagpole collar may be attached to the flagpole and coupled to the intermediate height flagpole connection member. One or more intermediate height flagpole collars may be provided.

In another aspect of the present teachings, the flagpole collar may include a gap for attachment and detachment defined within a part of peripheral wall that surrounds the insertion hole, from the top end to the lower end of the wall. The width of the gap is preferably less than the diameter of the flagpole in a normal or resting state thereof and can assume a size at least equal to the diameter of the flagpole by elastic expansion. When the gap elastically expands, the flagpole collar can be attached to the flagpole from the gap. After the flagpole collar has been attached to the flagpole, the gap may elastically return to the initial normal (resting) state in order to prevent detachment or removal of the flagpole collar from the flagpole. Thus, in this aspect as well, the flagpole collar can be easily attached to the flagpole and the flag can be efficiently attached to the flagpole.

In yet another aspect of the present teachings, a flag fixing member may be utilized to securely fix the upper portion of the flag to the upper support member. For example, the flag fixing member may be disposed on a distal end of the upper support member and may shift or pivot between a fixed position and an open position. In the fixed position, the flag fixing member extends in parallel to the upper support member with the flag fixedly disposed between the flag fixing member and the upper support member. In the open position, the flag fixing member may be pivoted away from the upper support member so as to permit the flag to be removed from the upper support member. The flag may include a loop that extends along the upper portion of the flag and the upper support member may be inserted through the loop. In this case, the loop may be interleaved between the flag fixing member and the upper support member. As a result, the flag (i.e., the loop of the flag) can not be removed from the upper support member.

The loop for the upper support member optionally may continuously extend along the entire length of the upper portion of the flag.

Additional objects, features and advantages of the present invention will be readily understood after reading the following detailed description together with the accompanying drawings and the claims.

### BRIEF DESCRIPTION OF THE DRAWINGS

FIG. 1 is a perspective view illustrating a flag set of the first representative embodiment and the third representative embodiment of the present teachings. Solid lines indicate the flag set of the first representative embodiment, and the flag set of the third representative embodiment is indicated by solid lines and two-dot-dash lines.

FIG. 2 is an exploded perspective view illustrating an upper part of the flag set of the first representative embodiment, in which the upper support member has been omitted.

FIG. 3 is an exploded perspective view illustrating an upper part of the flag set of the first representative embodiment, in which the flag has been omitted.

FIG. 4 is an exploded perspective view illustrating an upper part of the flag set of the first representative embodiment, in which the flag and the flagpole have been omitted. The flag mounting member is shown in a state in which it is viewed from above at an angle. The upper support member, installation member, and fixing member are shown in a state in which they are viewed from below at an angle.

FIG. 5 is a longitudinal sectional view illustrating an upper part of the flag set of the first representative embodiment, in which the flag has been omitted.

FIG. 6A is a perspective view of a representative flagpole collar of the flag set of the first and second representative embodiments of the present teachings. Solid lines indicate the flagpole collar of the first representative embodiment, and solid lines and two-dot-dash lines indicate the flagpole collar of the second representative embodiment.

FIG. 6B is a transverse sectional view illustrating the flagpole collar of the flag set of the first and second representative embodiments.

FIG. 7A is a perspective view illustrating a lower part of the flag set of the first and second representative embodiments. Solid lines indicate the flag set of the first representative embodiment, and the flag set of the second representative embodiment is indicated by solid lines and two-dot-dash lines.

FIG. 7B is a transverse sectional view illustrating a lower part of the flag set of the first and second representative embodiments. Solid lines indicate the flag set of the first representative embodiment, and the flag set of the second representative embodiment is indicated by solid lines and two-dot-dash lines.

FIG. 8 is an exploded perspective view illustrating an upper part of the flag set of the second representative embodiment.

FIG. 9 is a longitudinal sectional view illustrating an upper part of the flag set of the second representative embodiment.

### DETAILED DESCRIPTION OF THE INVENTION

In one embodiment of the present teachings, a first joining part may be disposed on an upper end of a flagpole. A flag may include a first joining loop disposed on an upper side edge of the flag. The first joining loop may be coupled to the first joining part without wrapping the joining loop around the flagpole.

In another embodiment of the present teachings, the flag may include a second joining loop provided on a lower side edge of the flag. A flagpole collar may be removably attached to the flagpole. For example, the flagpole may be received by an insertion hole defined within the flagpole collar. The flagpole collar may include a second joining part that is coupled to the second joining loop without wrapping the second joining loop around the flagpole.

In another embodiment of the present teachings, a second flagpole collar may be disposed around the flagpole between the first flagpole collar and the upper end of the flagpole. The second flagpole collar also preferably includes a third joining part. The flag may also include a third joining loop disposed between the first and second joining loops. The third joining loop also may be coupled to the third joining part without wrapping the third joining loop around the flagpole.

In another embodiment of the present teachings, at least one of the first and second flagpole collars preferably includes a gap defined within a peripheral wall of the flagpole collar from the top end to the lower end of the peripheral wall. The flagpole collar may be preferably made of an elastic material so that the width of the gap can be expanded in order to receive the flagpole. After the flagpole has been inserted into the flagpole collar, the flagpole collar preferably elastically returns to its original shape in order to securely attach the flagpole collar to the flagpole.

In another embodiment of the present teachings, a loop may be disposed along an upper edge of the flag. An upper support member having a substantially rod shape may be supported by the upper portion of the flagpole. The upper support member is preferably inserted through the loop so as to retain the upper portion of the flag on the upper support member. The loop may continuously extend along the upper edge of the flag.

Optionally, a flag fixing member may releasably retain the flag (or the loop of the flag) on the upper support member. For example, the upper support member may have an open and closed position. In the open position, the flag may be attached to or removed from the upper support member. When the flag fixing member moved to the closed position, the flag loop is preferably interleaved between the flag fixing member and the upper support member, thereby securely attaching the flag to the upper support member.

Each of the additional features and constructions disclosed above and below may be utilized separately or in conjunction with other features and constructions to provide improved flag sets. Detailed representative examples of the present teachings, which examples utilize many of these additional features and constructions in conjunction, will now be described in detail with reference to the accompanying drawings. This detailed description is merely intended to teach a person of skill in the art further details for practicing preferred aspects of the present teachings and is not intended to limit the scope of the invention. Only the claims define the scope of the claimed invention. Therefore, combinations of features and constructions disclosed in the following detail description may not be necessary to practice the invention in the broadest sense, and are instead taught merely to particularly describe some representative examples of the invention. In addition, various combinations of the present teachings may be made, even though not specifically enumerated, in order to provide additional embodiments of the present teachings.

First Representative Embodiment

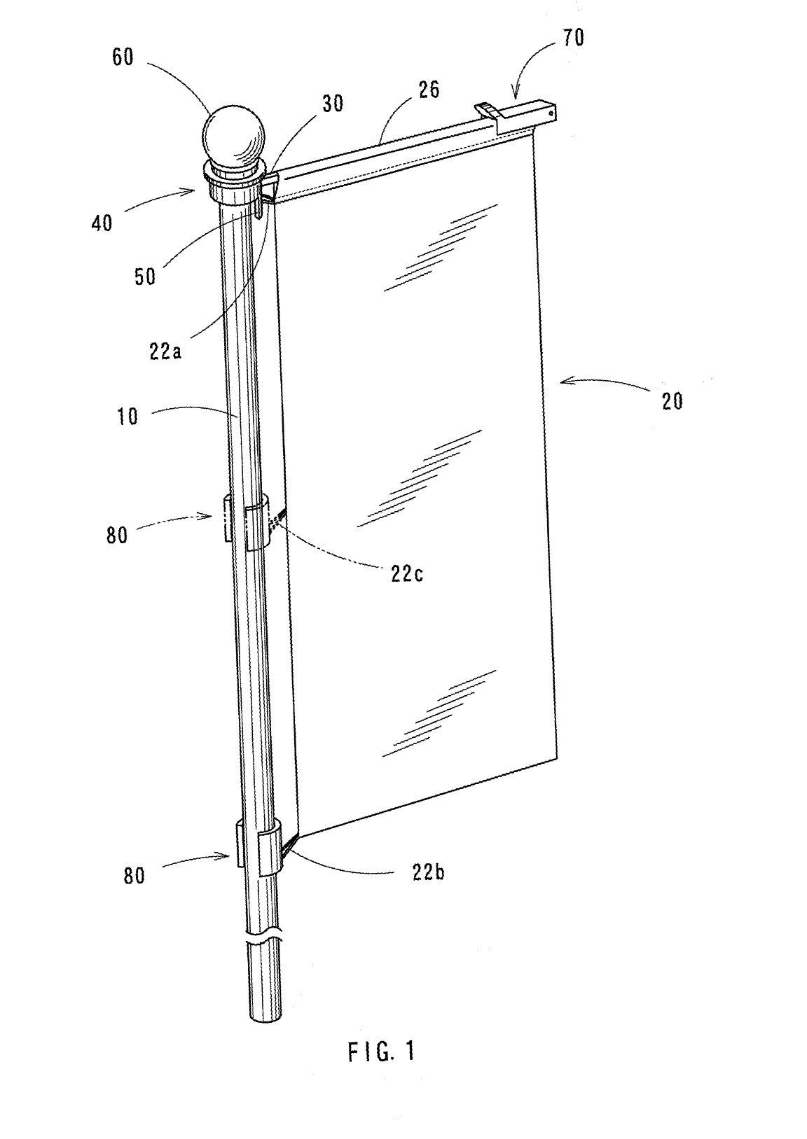

The first representative embodiment of the present teachings will be described below with reference to FIG. 1 to FIG. 7B. As shown in FIG. 1, the first representative flag set may include a flagpole 10, a flag 20, an upper support member 30, a flag mounting member 40, a flag fixing member 60, and a flagpole collar 80, each of which are shown in solid lines. Dashed lines indicate the third representative flag set of the present teachings, which will be described further below.

The flagpole 10 may be, e.g., a substantially hollow and cylindrical pipe. The flag 20 may be, e.g., a “banner” type flag having a longitudinal length that is longer than a lateral length. A plurality of (e.g., two in this embodiment) flagpole connection members coining loops) 22a, 22b may be disposed along one edge of the flag 20, i.e., the edge of the flag 20 that will be closest to the flagpole 10.

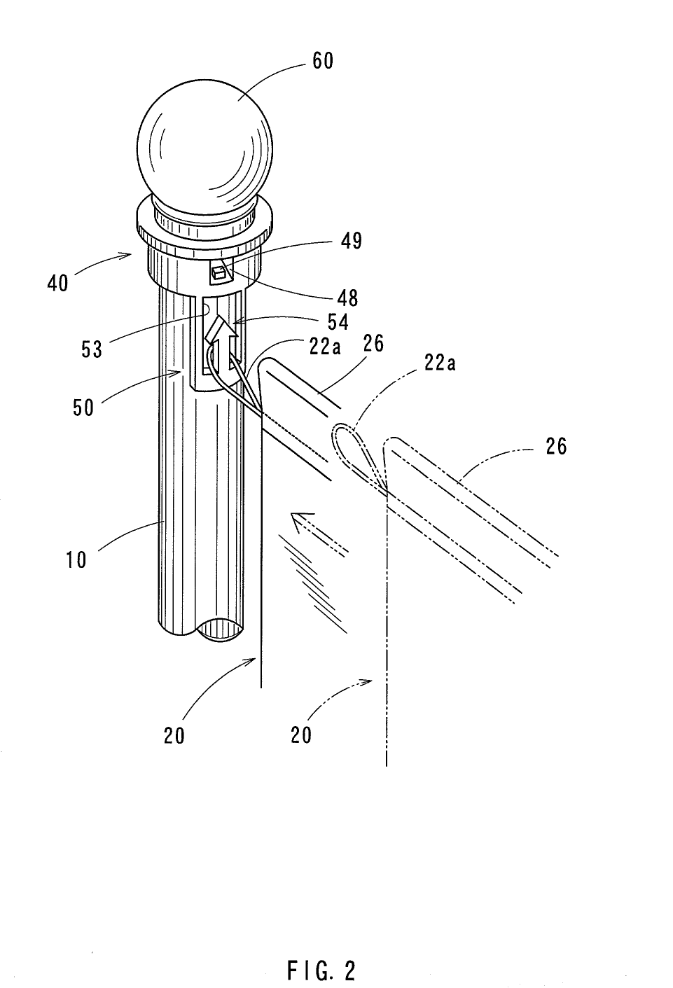

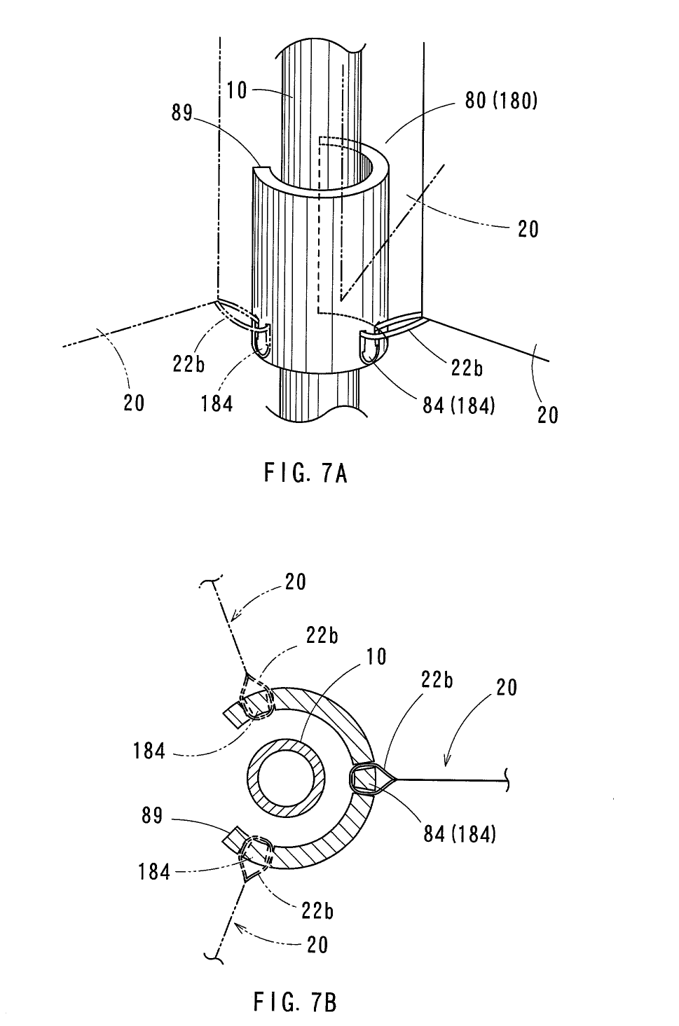

As shown in FIGS. 1 and 2, a first joining loop 22a may be disposed at the upper end of flag 20 and will be also referred to as an upper-end flagpole connection member 22a. As shown in FIGS. 1 and 7B, second joining loop 22b may be disposed at the lower end of flag 20 and will be also referred to as a lower-end flagpole connection member 22b. The first and second joining loops 22a, 22b may be formed from a cord or another string-like material, including synthetic resin material, and preferably has the shape of a loop. In addition, the base ends of the first and second joining loops 22a, 22b may be integrated (coupled or connected together), so that the front ends of the first and second joining loops 22a, 22b define a loop (e.g., a joining loop).

As shown in FIGS. 1 and 2, a loop 26 may be provided along the upper portion of the flag 20. The upper support member 30 may be inserted into the loop 26. The loop 26 may extend along the entire upper edge of the flag 20.

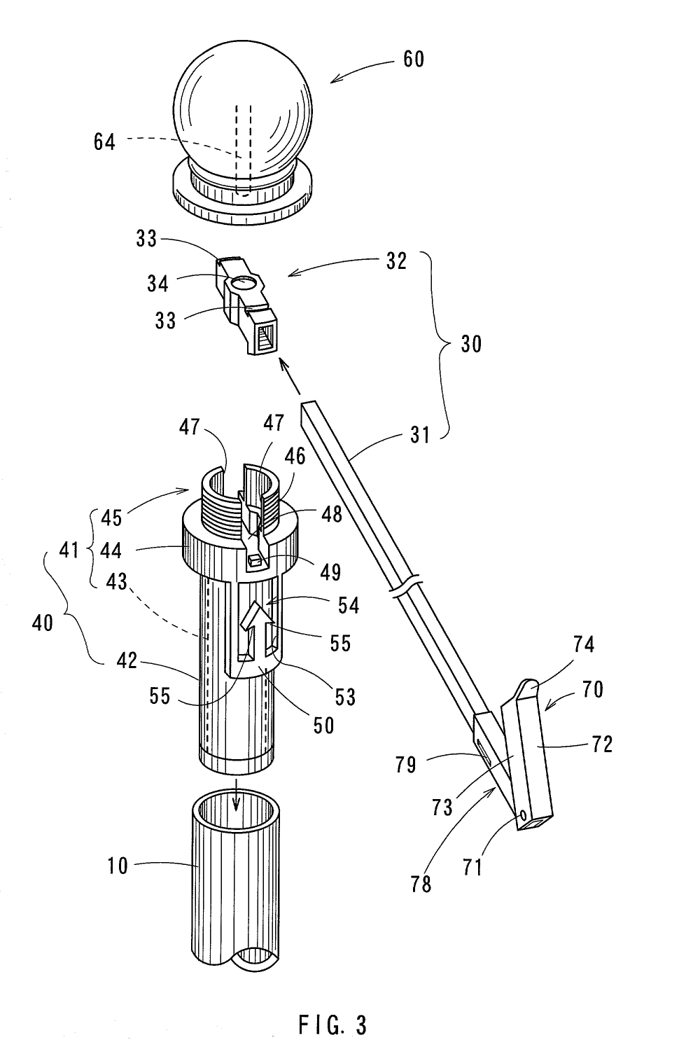

As shown in FIG. 3, the flag mounting member 40 may be removably coupled to the upper end of flagpole 10. As shown in FIGS. 3-5, the flag mounting member 40 may include, e.g., a main body 41 and an outer tube 42. The main body 41 may include a base shaft 43 that can rotate (slide) about the longitudinal axis of the outer tube 42. The outer tube 42 may be tightly fit (i.e., rotation about the longitudinal axis is restricted) onto the upper end of the flagpole 10. The base shaft 43 and the components located above the base shaft 43 can rotate about the longitudinal axis of the flagpole 10.

A flange 44 may be defined on the upper portion of the base shaft 43. A linking part 45 may be coupled to the upper portion of the flange 44. The linking part 45 may have a substantially cylindrical shape. A male thread 46 may be defined around the outer peripheral surface of the linking part 45.

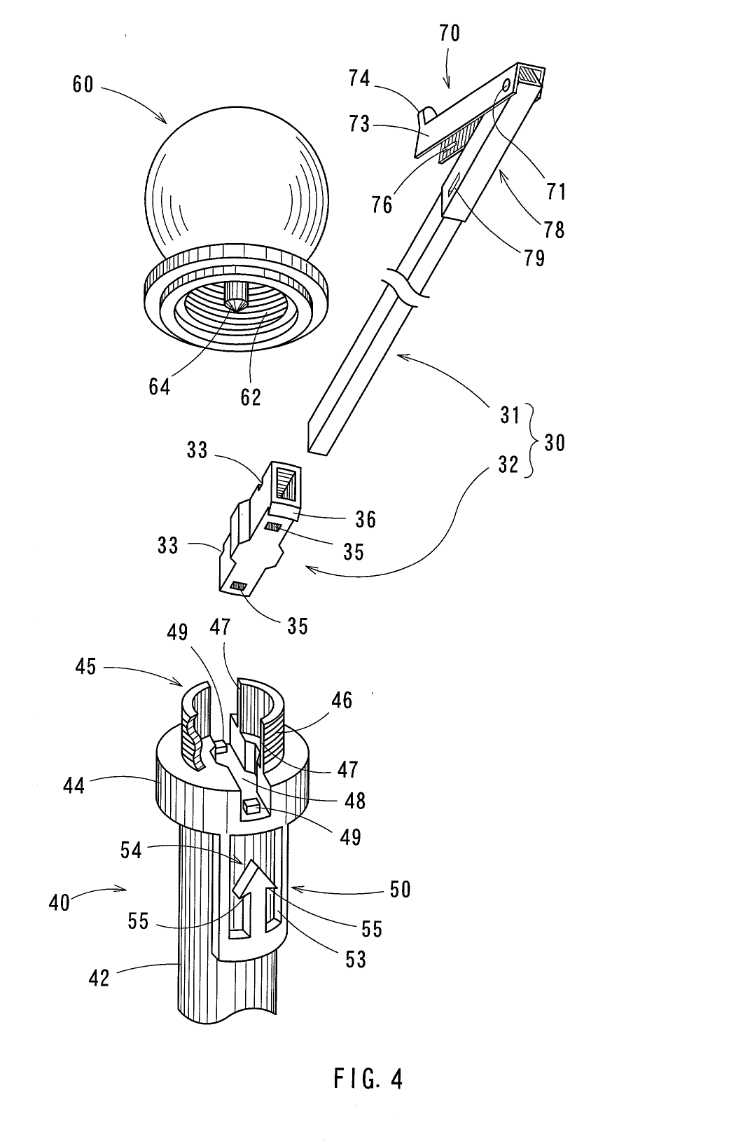

As shown in FIGS. 3 and 4, two mounting slots 47 may be defined within the linking part 45. The mounting slots 47 preferably extend downward (e.g., along the longitudinal direction of flagpole 10) from the upper end of the linking part 45 and may extend into the upper side portion of flange 44. A mounting groove 48 may be defined within the upper portion of the flange 44 in parallel with the mounting slots 47. The mounting groove 48 may extend through the center of the flange 44 and preferably intersects the flange 44 (e.g., at the upper portion thereof) such that the mounting groove 48 will correspond to the shape of the installation member 32, which will be further described below. Two small protrusions 49 are preferably disposed within the mounting groove 48.

The flag mounting member 40 also preferably includes a projection 50 that extends downward (e.g., substantially perpendicularly) from the flange 44. As will be further described below, a joining part 54 is preferably defined within the projection 50. An elongated quadrangular window 53 also may be defined within the projection 50. The joining part 54 may be, e.g., a hook that extends upward from the lower end of window 53. Two (left and right) catches 55 are included within the joining part 54. Preferably, the outer contours of the catches 55 gradually spread in mutually opposite directions from the upper end of joining part 54. The catches 55 each may include an acute angle with respect to the apexes thereof. For example, the top portion of each catch 55 may be triangular shaped, such that the catch 55 is defined as an arrow head shape.

As shown in FIGS. 3-5, the flag fixing member 60 may be removably attachable with the flag mounting member 40 (e.g., the linking part 45). The fixing member 60 may include a substantially cylindrical portion 63. In addition, the upper portion of the fixing member 60 may be enclosed so as to define a substantially spherical portion 61. A female thread 62 may be defined on the inner peripheral surface of cylindrical portion 63. The female thread 62 preferably corresponds to the male thread 46 of flag mounting member 40 (i.e., the linking part 45). The substantially spherical portion 61 may be replaced with other designs.

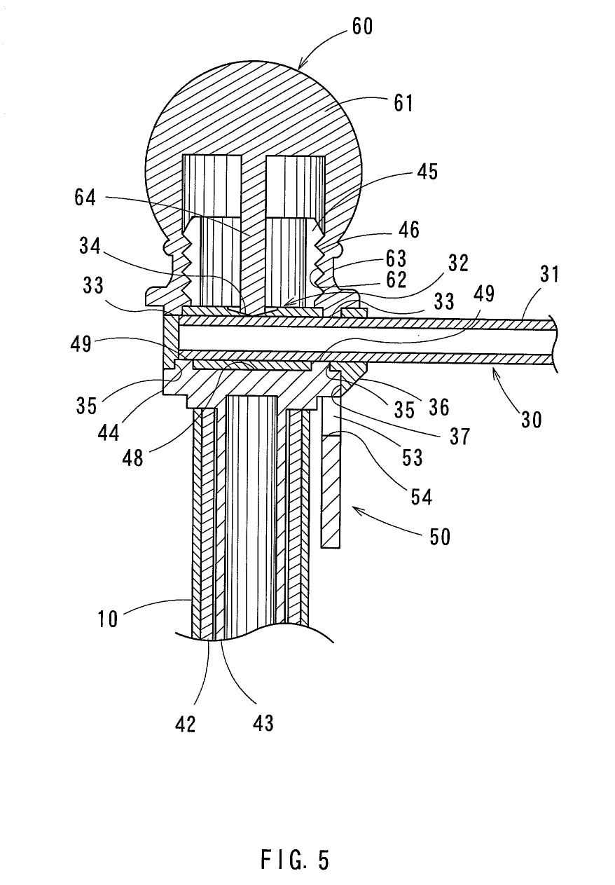

As shown in FIGS. 4 and 5, a contact rod 64 may be disposed within the fixing member 60, so as to extend downward from the spherical portion 61 along a central axis of the fixing member 60. The lower end of the contact rod 64 may be tapered in the downward direction. Further, the lower end of the contact rod 64 is preferably substantially flush with the lower end of cylindrical portion 63. Thus, the fixing member 60 (female thread 62) may be rotatably threaded onto the flag mounting member 40 (male thread 46) in order to securely retain the installation member 32 therebetween.

As shown in FIGS. 3 and 4, the upper support member 30 preferably includes a support rod 31 and the installation member 32. The support rod 31 may be a straight rod having a quadrangular cross section, although the support rod 31 may have other shapes, such as curved and/or rounded. The installation member 32 may be a quadrangular tube that is open at one end and closed at the other end. The open end of the installation member 32 may be press-fitted onto the base end of the support rod 31. The width of the installation member 32 preferably corresponds to the widths of the mounting groove 48 and the mounting slots 47. The central portion of the installation member 32 (i.e., the central portion in the longitudinal direction) is preferably wider than the other portions of the installation member 32.

Two grooves 33 may be defined within the upper part of installation member 32 so as to cross or traverse the installation member 32 in the lateral direction. The grooves 33 preferably are configured to receive the cylindrical portion 63 of the fixing member 60. A central recess 34 is preferably defined within the central part (i.e., the central part in the longitudinal direction) of the upper portion of installation member 32. The central recess 34 is preferably configured to receive the tapered end of the contact rod 64. Two small holes 35 may be defined within the lower surface of installation member 32, which small holes 35 preferably correspond to the small protrusions 49. When the support rod 31 is disposed within the installation member, the grooves 33 and the small holes 35 may expose the support rod 31 to the outside, as shown in FIG. 5.

As shown in FIGS. 4 and 5, a downward projection 36 may be defined on the lower surface of the base end of the installation member 32. The contact surface 37 (the surface on the side of the front end of the installation member 32) of the downward projection 36 preferably corresponds to the outer side surface of the flange 44. Thus, when the installation member 32 (upper support member 30) is attached to the flag mounting member 40 (mounting grooves 48), the contact surface 37 of the downward projection 36 contacts (or at least partially contacts) the outer side surface of the flange 44.

Referring to FIGS. 3 and 4, the flag fixing member 70 may be disposed on the front end of upper support member 30 so that the flag fixing member 70 is free to move or pivot between a fixed position (see FIG. 1) and an open position (FIGS. 3 and 4), as will be further described below. Further, a fitting member 78 may be attached to the front end of upper support member 30 (e.g., the support rod 31). The fitting member 78 may be, e.g., a quadrangular tube and is press-fit onto the front or distal end of upper support member 30. Grooves 79 may be defined within the respective left and right side surfaces of fitting member 78.

A pin 71 may rotatably or pivotally attach the flag fixing member 70 (i.e., a base end thereof) to the front end of upper support member 30 (fitting member 78). The flag fixing member 70 may be made of a synthetic resin having elastic properties. An upper plate 72 and a pair (left and right) of side plates 73 may be defined on the flag fixing member 70. The terms “the upper plate 72” and “downward” represent the orientation with reference to the fixed position state of the flag fixing member 70.

The front end of the upper plate 72 may serve as a control part 74. The length of the flag fixing member 70 is preferably about the same as the length of the fitting member 78. The width of the upper plate 72 preferably corresponds to the width of the upper surface of the fitting member 78. Protrusions 76 may be defined within each inner side surface of the side plates 73 at positions that correspond to the respective grooves 79.

Thus, when the flag fixing member 70 is in the fixed position, the protrusions 76 may engage the grooves 79 of fitting member 78. As a result, the flag fixing member 70 can be securely retained in the fixed position. When the flag fixing member 70 (control part 74) is rotated or pivoted towards the open position, the side plates 73 may elastically deform so that the protrusions 76 will disengage from the grooves 79. Of course, when the flag fixing member 70 (control part 74) is rotated or pivoted from the open position to the fixed (closed) position, the side plates 73 may elastically deform so that the protrusions 76 may engage the grooves 79.

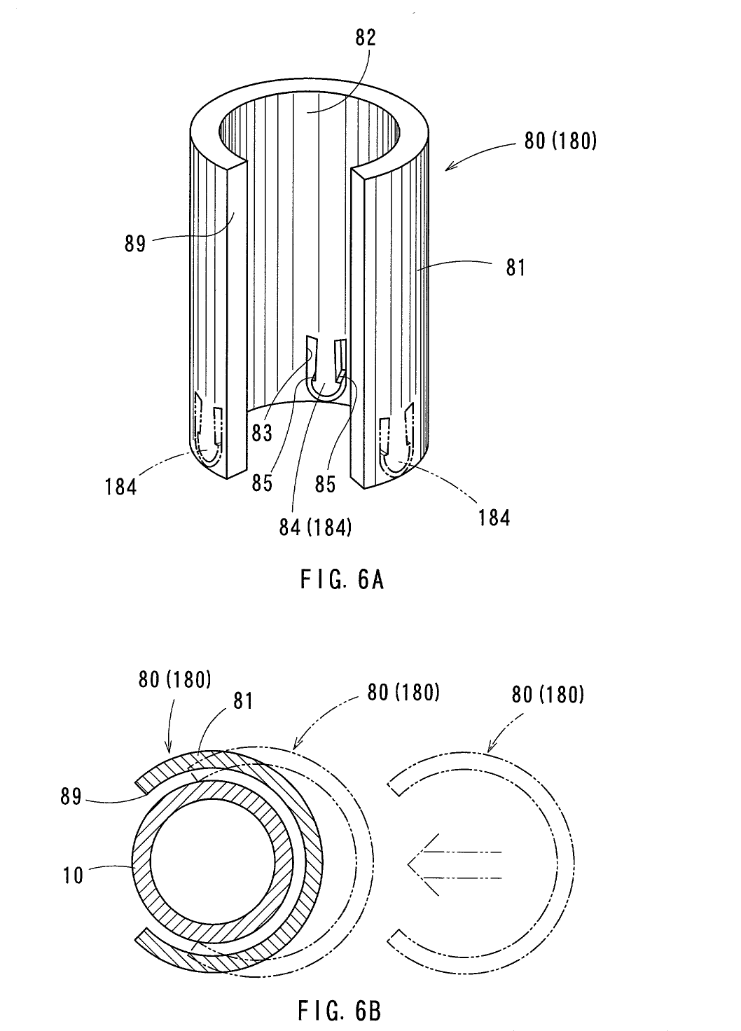

Referring now to FIG. 6A, the flagpole collar 80 may be made from an elastic material, such as synthetic resin. The flagpole collar 80 may have a substantially cylindrical shape that substantially corresponds to the outer periphery of the flag pole. The flagpole collar 80 may include a peripheral wall 81 and an insertion hole 82. A gap 89 is preferably defined from the top end to the lower end of peripheral wall 81 along the longitudinal direction. As shown in FIG. 6B, the width of gap 89 is preferably narrower than the diameter of flagpole 10 when the flagpole collar 80 is in a resting state. Naturally, because the flagpole collar 80 may elastically bend, the gap 89 also can elastically expand in order to become at least as wide as the diameter of flagpole 10. Thus, the flagpole collar 80 can be elastically joined or attached to the flagpole 10.

A joining part 84 may be defined within the flagpole collar 80. For example, a substantially U-shaped portion may be removed from the peripheral wall 81 in order to form a hook-like joining part 84. In addition, a window 83 is defined within the peripheral wall 81 and the joining part 84 extends downward from the upper end of window 83. A pair of, e.g., left and right, catches 85 may be defined within the joining part 84. The catches 85 may have a rounded shape with laterally extending edges for releasably retaining a joining loop of the flag.

A representative method for attaching the various elements of the above-described flag set will now be described. As shown in FIGS. 3 and 4, when the flag fixing member 70 is disposed in the open position, the upper support member 30 may be passed or inserted through the loop 26 of flag 20 (FIG. 1). Thus, the loop 26 can be attached to the upper support member 30.

Then, the upper support member 30 may be attached to the flagpole 10. For example, the flag mounting member 40 may be attached to the flagpole 10 and the fixing member 60 may be detached from the flag mounting member 40, as shown in FIG. 3. In this case, the upper support member 30 (installation member 32) may be inserted into the mounting slots 47 and the mounting groove 48, as shown in FIG. 3 and FIG. 4. At this time, the small protrusions 49 will fit into the small holes 35, as shown in FIG. 5. Further, the downward projection 36 (contact surface 37) will contact (or substantially contact) the outer side surface of the flange 44.

As shown in FIGS. 3-5, the fixing member 60 is then rotatably threaded onto the flag mounting member 40. As a result, the cylindrical portion 63 (the lower end thereof) of fixing member 60 will be inserted into the grooves 33 of the installation member 32 so as to contact the upper support member 30 (e.g., the support rod 31). In addition, the lower end of the contact rod 64 will be inserted into the central recess 34 of the installation member 32. Thus, the upper support member 30 (the base end thereof) is interleaved between the flag mounting member 40 and fixing member 60 and can be fixedly attached to the flagpole 10 in this representative manner.

In this state, the upper support member 30 can freely rotate around the longitudinal axis of the flagpole 10 and is maintained at a right angle (i.e., horizontal when the flagpole 10 is vertical) with respect to the flagpole 10. If the front end of upper support member 30 is bent downward, the contact surface 37 of downward projection 36 will apply pressure to the outer side surface of flange 44 in order to prevent bending.

Next, as shown in FIG. 2, the upper-end joining loop 22a is connected or coupled to the joining part 54 of the flag mounting member 40. In other words, the catches 55 will releasably retain the joining loop 22a in a secure manner. As a result, the upper-end joining loop 22a may be attached to the flag mounting member 40 and it is not necessary to wrap the upper-end joining loop 22a around the flagpole 10. In other words, as shown in FIG. 2, the upper-end joining loop 22a may be attached to the flagpole 10 via the flag mounting member 40.

Next, as shown in FIG. 1, the flag fixing member 70 is pivoted to the fixed position. As a result, the loop 26 of the flag 20 will be fixedly interleaved between the flag fixing member 70 and the upper support member 30 (i.e., fitting member 78). The flag 20 (loop 26) is thus attached to the upper support member 30 and displacement of the flag 20 (loop 26) with respect to the upper support member 30 is prevented.

As shown in FIG. 7A and FIG. 7B, the flagpole collar 80 also may be attached to the flagpole 10 and the lower-end joining loop 22b may be connected or coupled to the flagpole collar 80. For example, as shown in FIG. 6B, the gap 89 of flagpole collar 80 may be pressed against the flagpole 10. In this case, the gap 89 will elastically expand to a size nearly equal to the diameter of flagpole 10. As a result, the flagpole 10 can be inserted into the insertion hole 82 and the gap 89 will then return to the initial normal (resting) state. Thus, the flagpole collar 80 may be attached to the flagpole 10 in this manner so that the flagpole collar 80 can move along the axial direction of flagpole 10 and also can rotate about the longitudinal axis of flagpole 10. Further, as shown in FIGS. 7A and 7B, the lower-end joining loop 22b is connected or coupled to the joining part 84 of the flagpole collar 80.

Consequently, as shown in FIGS. 1, 7A and 7B, the lower-end joining loop 22b may be attached to the flagpole collar 80 without wrapping the lower-end joining loop 22b around the flagpole 10. In other words, the lower-end joining loop 22b may be attached to the flagpole 10 via the flagpole collar 80. Therefore, according to this embodiment, the flag 20 can be easily and efficiently attached to the flagpole 10.

Second Representative Embodiment

The second representative embodiment of the present teachings will be explained below with reference to FIGS. 6-9 with particular attention being paid to the differences between the second representative embodiment and the first representative embodiment. Elements identical to those in the first representative embodiment have been assigned the same reference numerals. Thus, further explanation is not necessary for elements that are common to both the first and second representative embodiments.

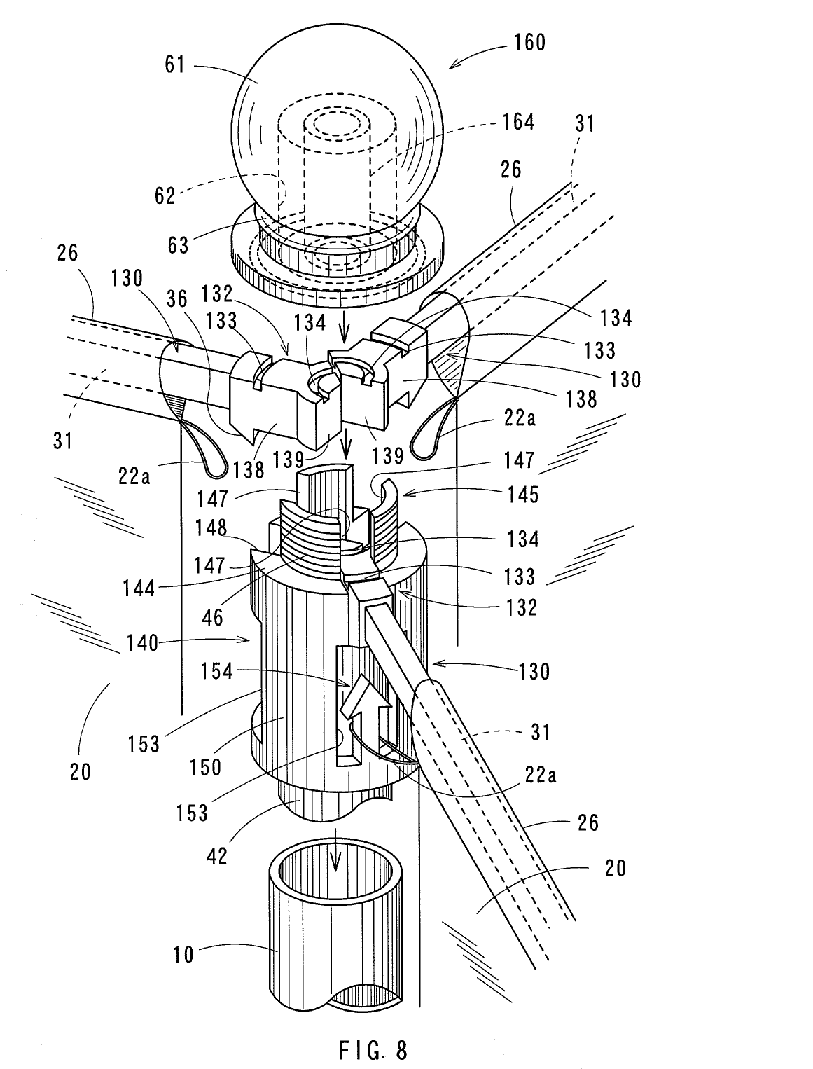

As shown in FIG. 8, the flag set of the second representative embodiment includes three flags 20. Similar to the first representative embodiment, two joining loops (i.e., upper-end joining loop 22a and lower-end joining loop 22b) may be disposed on one side edge of each flag 20. One loop 26 for the upper support member 130 (described below) also may be disposed along the upper portion of each flag 20.

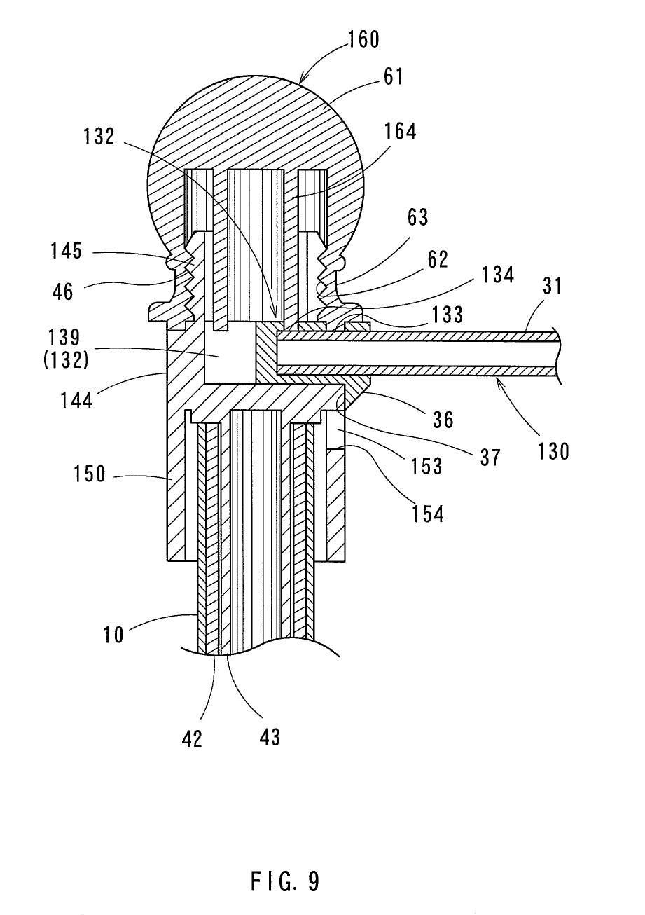

As shown in FIGS. 8 and 9, a flange 144 may extend from the upper part of the base shaft 43 of the flag mounting member 140. A substantially cylindrical linking member 145 may extend from the flange 144. Three mounting slots 147 may be defined within the linking member 145 at equal angular intervals (i.e., 120°). Each mounting slot 147 may extend downward from the upper end of the linking member 145 into the upper portion of the flange 144. Three mounting grooves 148 may be defined about the outer side portion of the linking member 145 and within the flange 144, such that the grooves 148 correspond to the respective mounting slots 147. The upper surface of the inner side portion of the linking member 145 is preferably flush with the bottom surfaces of the mounting grooves 148.

The flag mounting member 140 preferably includes a projection 150 that has a substantially cylindrical shape and extends downward from the flange 144. Three joining parts 154 may be provided at equal angular intervals within the projection 150. In other words, three windows 153 may be defined within the projection 150, and each joining part 154 may include a hook-like portion that extends upward from the lower end of the windows 153.

The flag fixing member 160 may include a substantially cylindrical portion 63 and the upper portion of the fixing member 160 may be enclosed by a substantially spherical portion 61. A contact cylinder 164 may be disposed within the fixing member 160 so as to extend downward from the substantially spherical portion 61 and concentrically along the central axial direction of the fixing member 160. The lower end of contact cylinder 164 is preferably substantially flush with the lower end of cylindrical portion 63.

The second representative flag set preferably includes three upper support members 130 that correspond to the three respective flags 20. An installation member 132 may be press-fit onto the base end of each support rod 31. One end of the installation member 132 preferably includes a substantially quadrangular tubular portion 138 and the other end includes a split disk-like portion 139. The substantially quadrangular tubular portion 138 is preferably closed. The split disk-like portion 139 preferably has a shape of a disk that has been divided into three sections. The size of the disk, which includes the combination of the split disk-like portions 139 of the three installation members 132, preferably corresponds to the size of the interior of linking part 145. Grooves 134 may be defined within the split disk-like portions 139 so as to correspond to the contact cylinder 164. Grooves 133 may be defined within the quadrangular tubular parts so as to correspond to the cylindrical portion 63.

As shown in FIG. 6A, three joining portions 184 may be defined within the flagpole collar 180. The joining portions 184 preferably have a hook-like shape (e.g., include a hook) and may be formed by removing substantially U-shaped portions from the peripheral wall 81. From a different viewpoint, three windows 83 may be defined within the peripheral wall 81, and joining portions 184 may extend downward from the upper end of windows 83.

A representative method for mounting the various elements of the second representative flag set will now be described. As shown in FIGS. 8 and 9, the upper support member 130 may be attached to the flagpole 10 as follows. First, when the flag mounting member 140 is attached to the flagpole 10 and the fixing member 150 is removed from the flag mounting member 140, the upper support members 130 (installation members 132) are fit into the mounting slots 147, mounting grooves 148, and the interior of the linking part 145 of flag mounting member 140.

Then, the fixing member 160 is rotatably threaded onto the flag mounting member 140. As a result, the cylindrical portion 63 (i.e., the lower end thereof) of fixing member 160 is inserted into the grooves 133 of the respective installation members 132 and contacts the upper support members 130 (e.g., the support rods 31). Further, the lower end of the contact cylinder 164 will be inserted into the grooves 134 of the respective installation members 132 and also will contact the upper support members 130 (i.e., the support rods 31). As a result, the upper support members 130 (i.e., the base end thereof) will be interleaved between the flag mounting member 140 and the flag fixing member 160. Therefore, the upper support members 130 are joined to the flagpole 10 so that the upper support members 130 can rotate about the longitudinal axis of the flagpole 10 and are maintained at a right angle (i.e., horizontal when the flagpole 10 is vertical) with respect to the flagpole 10.

The flags 20 may be attached to the upper support member 130 in the same manner as in the first representative embodiment. The flags 20 may be attached to the flagpole 10 in the following manner. Similar to the first representative embodiment, each upper joining loop 22a may be connected or coupled to each joining part 154. Therefore, the upper-end joining loops 22a can be attached to the flag mounting member 140 without wrapping each upper-end joining loop 22a around the flagpole 10. In other words, each upper-end joining loop 22a may be attached to the flagpole 10 via the flag mounting member 140.

Furthermore, as shown in FIGS. 7A and 7B, similar to the first representative embodiment, the flagpole collar 180 may be rotatably attached to the flagpole 10 and each lower-end joining loop 22b may be connected or coupled to each joining part 184. As a result, the lower-end joining loops 22b can be attached to the flagpole collar 180 without wrapping each lower-end joining loop 22b around the flagpole 10. In other words, each lower-end joining loop 22b may be attached to the flagpole 10 via the flagpole collar 180. Therefore, the flags 20 can be easily and efficiently attached to the flagpole 10.

Third Representative Embodiment

The third representative embodiment of the present teachings will now be explained with particular attention being paid to the differences between the third representative embodiment and the first and second representative embodiments. As shown by two-dot-dash lines in FIG. 1, the third representative flag set may include one additional joining loop (intermediate height joining loop) 22c disposed between the upper end and lower end of the side edge of flag 20 on the side of the flag that will be closest to the flagpole 10. One or more intermediate height joining loops 22c may be utilized at an intermediate height of the flagpole 10. The intermediate height joining loop 22c preferably has the same structure as the joining loops 22a, 22b. The flagpole collar 80 is preferably disposed so as to correspond to the intermediate height joining loop 22c and the joining loop 22c is connected or coupled to the flagpole collar 80 (i.e., the connection portion 84 thereof). As a result, the intermediate height portion(s) of the flag 20 also may be attached to the flagpole 10 via the flagpole collar(s) 80.

In the third representative flag set, one or more additional joining loops may be disposed within the portion (intermediate height portion) between the upper end and lower end of the side edge of each flag 20 on the side that faces the flagpole 10. If the intermediate height joining loop 22c has the same structure as the joining loop 22a, 22b, the flagpole collar 180 may be disposed so as to correspond to the intermediate height joining loop. Further, each intermediate height joining loop 22c may be connected to the flagpole collar 180 (i.e., the connection portion 184 thereof). As a result, the intermediate height portion(s) of each flag 20 also can be attached to the flagpole 10 via the flagpole collar(s) 180.

Flag sets of the present teachings are not limited to the above-described representative embodiments and a variety of modifications can be made to the present teachings without departing from the spirit of the present teachings. For example, the number of flags (20) attached to the flagpole (10) is not limited to one (first representative embodiment) or three (second representative embodiment) and may be two or any other number.

Additional teachings relevant to the present disclosure can be found in US Published Patent Application No. 2001-0022153, the contents of which are incorporated herein by reference as if fully set forth herein.

1. An apparatus comprising:
a flagpole,
a first joining part rotatably disposed on an upper end of the flagpole, and
a flag comprising at least a first joining loop disposed on an upper side edge of the flag, wherein the first joining loop is coupled to the first joining part without wrapping the joining loop around the flagpole.

2. An apparatus as in claim 1, further comprising:
a second joining loop disposed at a lower side edge of the flag, and
a first flagpole collar rotatably disposed around the flagpole, the first flagpole collar comprising a second joining part releasably retaining the second joining loop without wrapping the second joining loop around the flagpole.

3. An apparatus as in claim 2, further comprising:
a third joining loop disposed on the side of the flag between the first and second joining loops, and
a second flagpole collar rotatably disposed around the flagpole, the second flagpole collar comprising a third joining part releasably retaining the third joining loop without wrapping the third joining loop around the flagpole

4. An apparatus as in claim 2 or 3, wherein the first and second flagpole collars include a gap defined within a peripheral wall of the flagpole collar from the top end to the lower end of the peripheral wall, wherein the gap has a width that is less than the diameter of the flagpole in a resting state of the flagpole collar and the gap can be elastically expanded in order to receive the flagpole within the insertion hole.

5. An apparatus as in any of claims 1-4, wherein the first joining part is defined within a projection of a flag mounting member that is rotatably disposed on the upper end of the flagpole.

6. An apparatus as in claim 5, wherein the joining part comprises a catch or a hook that extends upward from a lower end of a window defined within the projection.

7. An apparatus as in claim 6, wherein the joining part comprises two catches having outer contours that gradually spread in mutually opposite directions from an upper end to define a substantially triangular shape.

8. An apparatus as in any one of claims 1-7, further comprising:
a loop disposed along an upper edge of the flag,
an upper support member having a substantially rod shape and being rotatably supported by the upper portion of the flagpole, wherein the upper support member is inserted through the loop so as to retain the upper portion of the flag, and
a flag fixing member disposed at a distal end of the upper support member, wherein the flag fixing member is arranged and constructed to pivot between a flag fixing position and an open position, wherein the loop is securely interleaved between the upper support member and the flag fixing member in the flag fixing position.

9. An apparatus as in any of claims 5-8, further comprising an installation member disposed on a base end of the upper support member, wherein the installation member is disposed within mounting slots and mounting grooves defined within the flag mounting member.
